(19) United States
(12) Patent Application Publication
(10) Pub. No.: US 2021/0382923 A1
(43) Pub. Date: Dec. 9, 2021

(54) SYSTEMS AND METHODS OF QUESTION ANSWERING AGAINST SYSTEM OF RECORD UTILIZING NATURAL LANGUAGE INTERPRETATION

(71) Applicants: Louis Rudolph Gragnani, Clayton, NC (US); Rishi Bhatnagar, Waxhaw, NC (US)

(72) Inventors: Louis Rudolph Gragnani, Clayton, NC (US); Rishi Bhatnagar, Waxhaw, NC (US)

(21) Appl. No.: 17/339,150

(22) Filed: Jun. 4, 2021

Related U.S. Application Data
(60) Provisional application No. 62/704,962, filed on Jun. 4, 2020.

(51) Int. Cl. G06F 16/332; G06F 16/33; G06F 40/20

(52) U.S. Cl. CPC G06F 16/3329; G06F 40/20; G06F 16/3344

(57) ABSTRACT

Provided are systems and methods for natural language interpretation, wherein a user's ambiguous natural language question or command is transformed into the most relevant understood query or list of queries). The query may be executed against a system of record to retrieve the answer to the user's question or command. The present invention also provides a systems and methods for natural language generation, wherein abstract query expressions may be transformed into either question texts or answer texts or both. The present invention provides a systems and methods for procedural generation of training data, wherein configurations defined by data elements provided by the system of record are transformed into a large enough number of question/answer examples necessary to train the query model. The systems and methods allow an interpretation system and method to produce useful results even if authorized users have added no explicit examples of question/answer pairs.

### RELATED APPLICATIONS

This patent application claims the priority to U.S. Provisional Application Ser. No. U.S. 62/704,962, filed on Jun. 4, 2020, entitled “System and Method of Question Answering Against System of Record Utilizing Natural Language Interpretation”, which is incorporated by reference herein.

### FIELD OF THE INVENTION

The inventive concept relates to systems and methods for answering questions by retrieving data from a system of record utilizing natural language interpretation. More specifically, the invention pertains to retrieving answers from a system of record by way of transforming the user's question or command into one or more executable queries.

### BACKGROUND

Ideally, interactions between a human user and a search engine would allow the user to present a request in a natural language format. For example, when performing a search, a human user may inquire, “What were the total tax breaks for solar panel installation by year.” This natural language expression can present difficulty to a search engine due to ambiguity in the phrasing. The processor of the search engine is tasked with managing ambiguity within the request and providing a result. The processor would discern the context and provide the desired result. Discerning the context requires the processor to implement query models that iteratively produce a range of results. The query models can learn from previous data or data samples. The query models can then increase in accuracy through repetition. However, large amounts of data is necessary to train models to reach robust conversational performance in user dialogs. Interaction data may not be available when a conversational system is initially deployed.

### BRIEF DESCRIPTION OF THE DRAWINGS

Some embodiments of the present invention are illustrated as an example and are not limited by the figures of the accompanying drawings.

FIG. 1 is a relational view of software components in one embodiment.

FIG. 2 is a depiction of a user interface view.

FIG. 3 is a depiction of a second user interface view.

FIG. 4 is a depiction of a third user interface view.

FIG. 5 is a flow chart illustrating a method for interpreting a question/answer request.

FIG. 6 is a flow chart illustrating a method for constructing a discourse.

FIG. 7 is a flow chart illustrating a method for disambiguating a requested question.

FIG. 8 is a block diagram illustrating neural network output tasks for a query model.

FIG. 9 is a flow chart illustrating a method for semi-supervised training a query model.

FIG. 10 is a block diagram illustrating a query model with component column models.

### BRIEF SUMMARY OF THE INVENTION

Tools and techniques for answering questions by retrieving data from a system ofrecord utilizing natural language interpretation are described. More specifically, the invention pertains to the use of machine learning to retrieve answers from a system of record by way of transforming the user's question or command into one or more executable queries. In addition, the present invention pertains to the use of natural language generation as it pertains to automatically creating training data for a query model, removing the startup cost associated with seeding such a system with user-defined examples of explicit question/answer pairs.

In an embodiment of the present invention, systems, and methods for procedural generation of training data are provided, wherein a configuration defined by the previously defined configurations, are applied to the training data. The training data is transformed into a large enough number of question/answer examples necessary to train the query model. These systems and methods for procedural generation of training data allow for an interpretation system and method to produce useful results even if authorized users have added no explicit examples of question/answer pairs. In this manner, the present invention avoids the “cold start problems” that exist in prior art.

As an example, in one embodiment, the method of procedural generation comprising: a step wherein authorized users define how to connect with systems of record, such as external databases. The authorized users can define further metadata about the resources stored by these systems of record. The system iteratively analyzes these resources to generate candidate abstract queries. These candidate abstract queries are filtered down to only those queries which execute without throwing an exception. The candidate abstract queries are paired with question texts. The question text is generated from the user's initial query. These question/query pairs are converted into samples. In another embodiment, a module to improve the accuracy of the interpretation splits the samples into training and validation sets. In some embodiments, this split can be defined by the class labels taken from one or more output tasks of the model.

In another embodiment, systems and methods for natural language interpretation are provided, wherein a user's ambiguous natural language question or command is transformed into the most relevant understood query (or most relevant list of queries). The query can then be executed against a system of records to retrieve the answer to the user's question or command.

According to various embodiments of the present invention, systems and methods for natural language generation (“NLG”) are provided, wherein abstract query expressions may be transformed into either question texts or answer texts or both. For example, in one embodiment, a configuration may be defined for the data elements provided by the system of record. The interpreter configuration can comprise identifiers for natural language expressions. The abstract query's constituent identifiers are used to lookup the associated natural language expressions. In a further step, a template string is decided for the result of the abstract query. In some embodiments, the chosen template varies depending on whether the final output should be a question text or an answer text. In some embodiments, the chosen template is selected from one of several logical forms, where the logical form is a property derived by inspection of configuration associated to the query's identifiers; in general, a step wherein the final output string is generated by substitution of the query's associated terminal expressions into the chosen template string.

### DETAILED DESCRIPTION OF THE INVENTION

The disclosed methods, apparatus, and systems are to be considered as an exemplification of the invention and is not intended to limit the invention to the specific embodiments illustrated by the figures or description below. Instead, the present disclosure is directed toward all novel and nonobvious features and aspects of the various disclosed embodiments, alone and in various combinations and sub-combinations with one another. Furthermore, any features or aspects of the disclosed embodiments can be used in various combinations and sub-combinations with one another. The disclosed methods, apparatus, and systems are not limited to any specific aspect or feature or combination thereof, nor do the disclosed embodiments require that any one or more specific advantages be present, or problems be solved.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, can be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently.

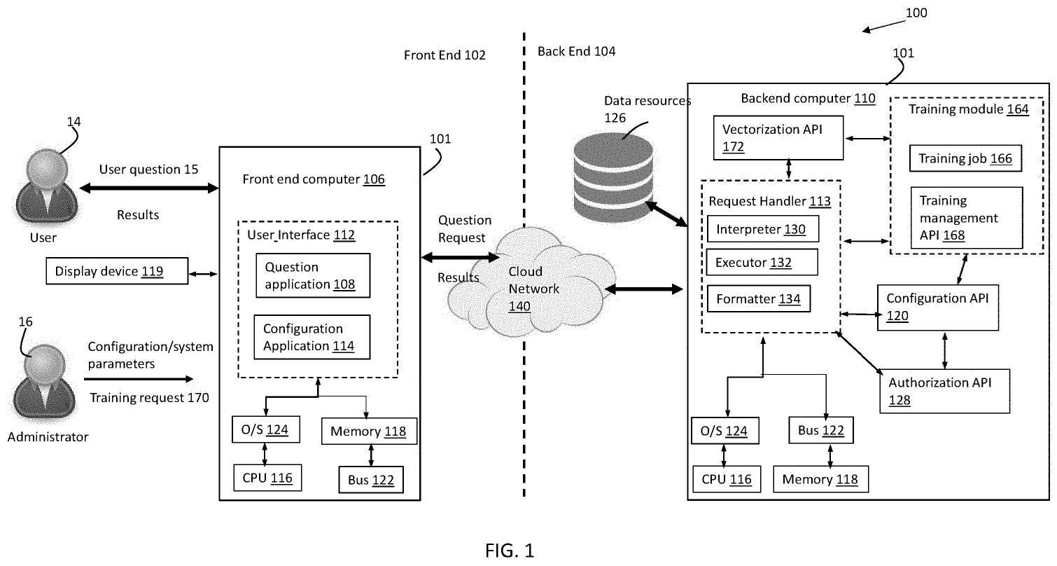

FIG. 1 is a schematic block diagram showing an example system (operating environment) 100 including a frontend system 102 and a backend system 104. The methods and systems disclosed can utilize one or more computers to perform one or more functions in one or more locations. This system 100 is only an example of an operating environment and is not intended to suggest any limitation as to the scope of use or functionality of operating environment architecture. Neither should the operating environment 100 be interpreted as having any dependency or requirement relating to any one or combination of components illustrated in the exemplary operating environment 100.

The frontend system 102 can comprise a computing device 101, such as a frontend computer 106. The backend system 104 can also comprise a computing device 101, such as a backend computer 110. In an alternative embodiment, the frontend computer 106 and backend computer 110 can be hosted physically in the same computing device 101. In a further aspect, the frontend computer 106 and backend computer 110 can comprise multiple physical devices located at different locations, while all devices remain in communication with one another.

The computer 110/106 can operate in a networked environment 140 using logical connections between the frontend 102, backend system 104, and data resource 126. For example, the computing device 101 can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. The computing device 101 interactions with the network 140 can comprises a local area network (LAN) and/or a general wide area network (WAN). Communication via the network 140 can be implemented in both wired and wireless environments via a transceiver. Such networks 140 are conventional and commonplace in dwellings, offices, enterprise-wide computer networks, intranets, and the Internet.

Further, one skilled in the art will appreciate that the systems and methods disclosed herein can be implemented via a general-purpose computing device 101 in the form of a computer 106/110. The computing device 101 can comprise one or more components, such as one or more processors 116, a system memory 118, and a bus 122 that couples various components of the frontend computer 102 and backend computer 110. In the case of multiple processors 116, the computer 106/110 can utilize parallel computing. The bus 122 can comprise one or more of several possible types of bus structures, such as a memory bus, memory controller, a peripheral bus, an accelerated graphics port, and a processor or local bus using any of a variety of bus architectures. The bus 122 can also be in communication over a wired or wireless network connection with one or more of the components of the computing devices 101, such as the one or more processors 116, an operating system (O/S) 124, and system memory 118. In a further aspect, the user interface 112 can comprise a human machine interface device (not shown). Examples of such human machine interface devices comprise, but are not limited to, a keyboard, pointing device (e.g., a computer mouse, remote control), a microphone, a joystick, a scanner, tactile input devices such as gloves, and other body coverings, motion sensor, and the like. In a further aspect, the question application 108 can convert audio signals from a microphone into text using a text-to-speech protocol to convert a question received from a microphone into text data for a subsequent query.

In yet another aspect, a display device 119 can also be connected to the bus 122. It is contemplated that the computing device 101 can have more than one display device 119. For example, a display device 119 can be a monitor, an LCD (Liquid Crystal Display), light emitting diode (LED) display, television, smart lens, smart glass, and/or a projector. In addition to the display device 119, other output peripheral devices can comprise components such as speakers (not shown) and a printer (not shown) which can be connected to the computing device 101 via an Input/Output Interface (not shown).

For purposes of illustration, application programs and other executable program components such as the operating system (O/S) 124 are illustrated herein as discrete blocks, although it is recognized that such programs and components can reside at various times in different storage components of the computing device 101 and are executed by the one or more processors 116 of the computing device 101. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable, and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computing device.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, protocols, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory 118 or external storage devices (data resources) 126. In a further aspect, the methods and systems can employ artificial intelligence (AI) techniques such as machine learning and iterative learning. Examples of such techniques include, but are not limited to, expert systems, case-based reasoning, Bayesian networks, behavior-based AI, neural networks, fuzzy systems, evolutionary computation (e.g., genetic algorithms), swarm intelligence (e.g., ant algorithms), and hybrid intelligent systems (e.g., Expert inference rules generated through a neural network or production rules from statistical learning).

The frontend system 102 can provide a configuration administrator 16 access to a configuration application 114. The configuration application 114 can provide configuration administrators 16 and users 14 with the ability to change the system parameters through configuration application program interface (API) 120 in the backend 104.

Formal query languages may be used to make queries having pre-defined syntax. Structured Query Language (SQL) may be used for queries using data in the data resources 126. In an alternate embodiment, NoSQL query language may be used when the data resource is not a relational database. In another aspect, the queries input by the user on the user interface 112 may use services and native calls of backend system 104.

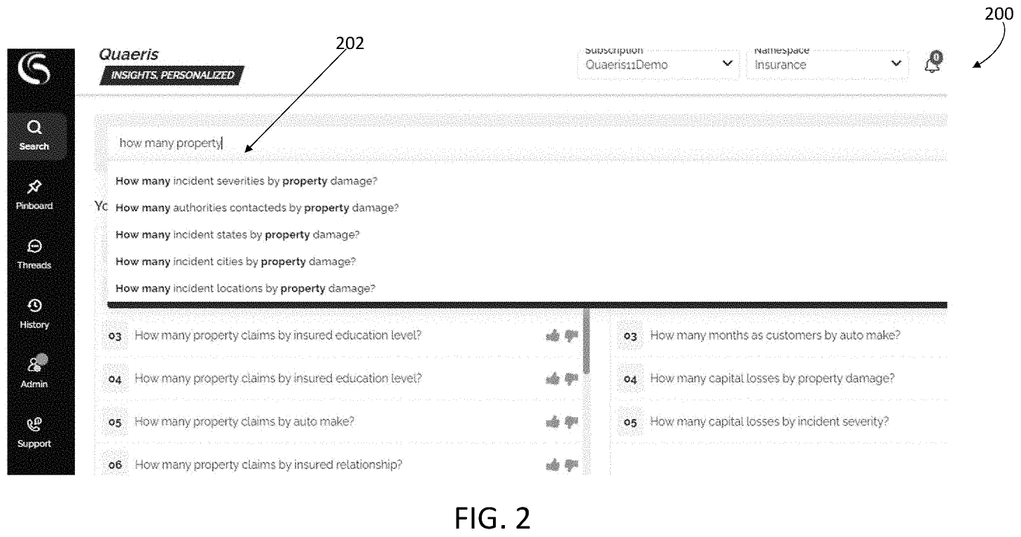

In initiating a query from the user 14, the frontend 102 components process a query in either a discovery flow or search flow. In one embodiment, the discovery flow allows the software to bring questions or answers to the user's attention. Once a user finds a line of questioning, the search flow operation can ask questions and get quick answers. As shown in FIG. 2, the user interface 112 depicts a Search flow paradigm 200. In using the search box 202 on the user interface 112, the user can enter data into the search box, similar to a search engine. In a further aspect, the backend server 104 may assist the user by predictively providing potential queries that the user may seek an answer. In another aspect, the user may provide the text to the search box via a text-to-speech. In a further aspect of the search flow, the user interface can display entire questions based on the predictive capability of the system. After generating training questions, the training questions can be indexed into a storage of the backend of the system or in the front end. In a further aspect, the indexed questions can be included in an autocomplete functionality of an API hosted on the backend 106. Upon the user's providing a partial question request, the autocomplete API can search from questions indexed in storage. In a further aspect the autocomplete API can provide a plurality of possible questions via a drop-down menu beneath the search box. In an alternative embodiment of the search flow, the system can receive and index a plurality of phrases. The text phrases can be indexed in the internal system memory 118 and/or external data resources 126. The configuration API 120 can receive a user's partial question. The partial question in the form of text data can also include metadata objects. In a further aspect, the metadata objects can include previously completed phrase metadata. The configuration API 120 can provide a list of sentence fragments containing the original question text along with a predicted phrase. Based on the total question phrase, the user can choose to select the predicted phrase or further continue to provide text for a potential query.

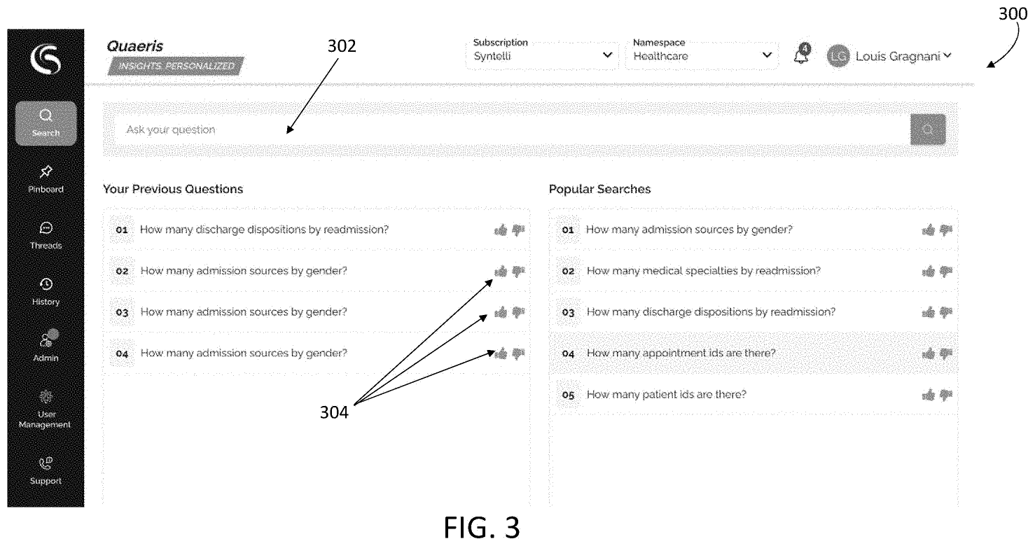

In another embodiment, the query can be processed in a discovery flow as depicted in the user interface of FIG. 3. The discovery flow can be used when users do not already have in mind a current line of questioning. The discovery flow can provide a method of asynchronous query recommendation or a method of discovering trending topics. For example, the discovery flow provides an interface 300 analogous to a social media timeline or a news feed. Similar to the Search Flow user interface, the user can provide text input to a text box 302. During implementation Query IDs can ranked by a naive “trending” score. The score is a ratio of frequencies: how often the Query ID has been asked over last 24 hours, versus the baseline expected historical frequency of that same Query ID. In another embodiment, the discovery flow user interface can make a query more efficient by adding a recommendation engine (not shown) to the system 100. The recommendation system can predict relevant Query IDs based on the given User ID. For example, the thumbs up/thumbs down icons 304 can provide data to define these associated-user rankings. Implicit user rankings can be inferred by a user's history of questions, as well as other signs of engagement, such as sharing the question with other users. The Query ID represents the user's unambiguous intent. This avoids any need to account for linguistics in the recommendation analysis. In a further aspect, the frontend 102 can comprise either a single-page application (SPA), a chatbot, or both. In yet another aspect, a secondary chatbot can be operating in the backend system 104 and allows the administrator 16 to control activities between the backend software modules including: the interpreter 130, executor 132. and formatter 134.

Referring back to FIG. 1, user question 15 can comprise a text representation received from a keyboard device or a text conversion of an audio signal from the user. The user question 15 can also include any session information and/or credentials for user 14. In a further aspect, the question application 108 may request access credentials from an authorization API 128 hosted on the backend 104. In one aspect, the authorization API 128 can implement security protocols. The security protocols can involve security steps that validate the user and determines their ability to communicate with the application. In another aspect, the user interface 112 can include a configuration application 114. The configuration API 114 can be configured by an administrator 16. The administrator 16 can define parameters and protocols necessary for a user to have proper authorization to access the question application via the configuration authorization API 120. The configuration API 120 controls parameters including the ability to configure metadata objects, value ontologies, and entity ontologies.

The question application 108 can transmit the user question 15 via the network to a request handler 113 in backend system 104. The request handler 113 can be an application program interface API that processes the user question 15 by controlling the flow of execution between other program modules including: the interpreter 130, executor 132, and formatter 134. At the conclusion of the overall search, the results from the backend 104 to the frontend 102 can be displayed on the display device 119; the question application 108 can provide the compiled query. In another aspect, additional questions that may a yield the same answer can be provided. In a further aspect, a second question can be made wherein the user interface can utilize search parameters from previous searches. In the event that query results involve tabular or chart data, question application 108 can provide statistical analysis tools including calculations and trendlines. Further, the resulting data can be shared externally via a weblink or data export functionality.

After receiving the request data from the question application 108, the request handler 113 can initiate processing the initial user question 15 at the interpreter 130. The interpreter 130 is a software module that evaluates the ambiguity of the user question 15. The user's question is an expression of some intended query-to-be-run, but this intent can generally be interpreted several ways (because natural language expressions are, in general, ambiguous). Interpreter 130 can predict the most likely interpretations of the user question 15.

In one aspect, the system 100 can increase the manner of efficiency for executing a query by reducing processing requirements and storage capacity. Prior inventions may have operated under a ‘cold start’ model which requires multiple iterations and storage capacity for each search to execute a query. In one aspect, the system 100 can address the restrictions of cold start problems by generating a discourse. A discourse can comprise pairs of questions(requests) and the associated responses that are provided to the request handler 113. The discourse can address cold-start problems by allowing the system to “remember” the context of recent history, bypassing a need to continually train models 1002 and 1004 just to account for short-lived trends in user behavior. As a result, the history defined by the discourse can increase the likelihood that an answer provided to a request has a higher likelihood of being the correct answer to a question. This increase in likelihood can be possible because the discourse shows user's questions are not random, and there is a clear commonality between the pairing based on the user's short-term goals.

The executor 132 is a software module responsible for deciding how to execute each interpretation (abstract query) predicted by interpreter 130. In a further aspect, the executor 132 can be configured with a supervisory control in executing tasks, while also delegating source-specific implementation details. For example, the executor 132 can delegate the responsibility of: query compilation; query execution at the data resource 126; and retrieval of results to a lower-level execution driver. The lower-level execution driver can be protocols that comprise source-specific implementation. Then, the executor 132 can decide the applicable driver by matching lower-level execution driver to the interpretation's predicted data resource. One skilled in the art will appreciate that different data resources 126 (RDBMS, Document Stores, REST APIs) must be queried using different languages and protocols (SQL, NoSQL, HTTP Request). Each database type has its own grammar. This grammar is identified and executed by executor 132. The executor 132 can apply the grammar when it takes a Filtered Query ID as input and returns the executable query (which is to be sent to the database). The connection details for this query are a property of connection information executed through the configuration API 120. Specifically, the connection information is stored as an encrypted connection string. Finally, to decide which connection object to use, the executor 132 can decode the column data referenced by the Query ID. This high level/low level delegation structure by the executor module 132 can allow the backend operations to function more efficiently.

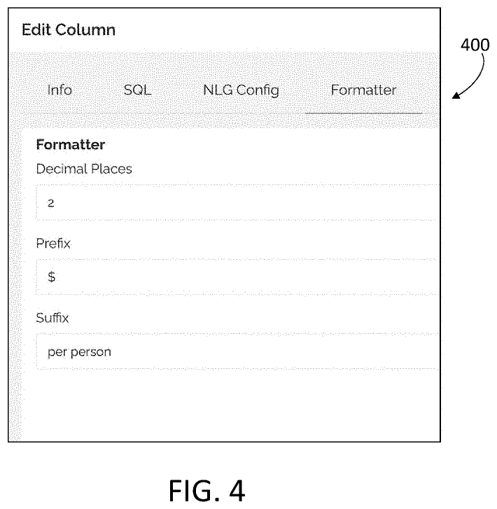

The formatter 134 is a software module responsible for applying formatting templates to render result values in a format suitable for the end-user. The applied templates may be specified by the user 14 within the user question 15 or specified by an administrator 16 in the configuration of the metadata term describing the result value as understood in the given interpretation. For example, as depicted in FIG. 4, the user or administrator can define the formatting template 400. The formatter 134 can bind the returned values of a result from a data resource 126.

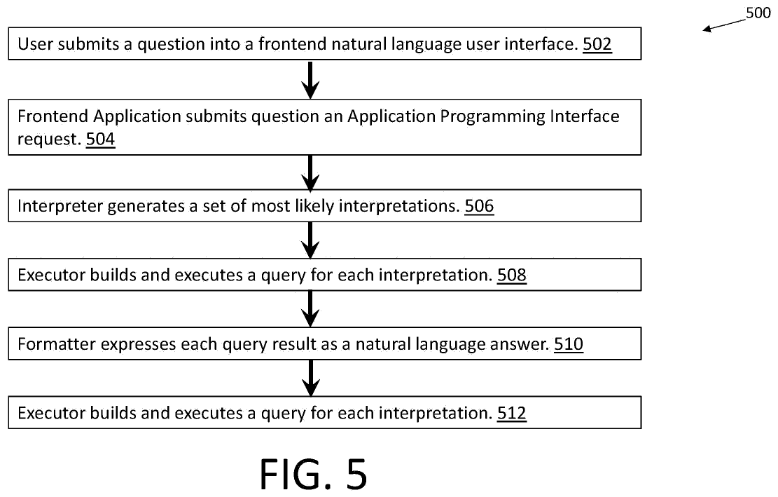

Referring now to FIG. 5, a flowchart describing a method for processing the interpretation request lifecycle of user question/answer is illustrated. The Method 500 can initiate at step 502 when the user 14 decides a question to ask. At step 502, the user 14 enters their question into user interface 112. At step 504, control flow of the request data passes from the client-side user application 108 to the back end (server-side) request handler 113, through submission and handling of question/answer request 105. In another aspect, this step may involve additional protocol tasks including: request authorization, event logging, payment, and session management.

When the request handler 113 is initialized by receiving user input from the question application 108, the request handler 113 can use a bind function to perform an operation on the user question 15. Once the query model 1002 has been successfully trained by method 900, step 918 triggers request handler 113 to load the newly trained model into memory for subsequent use.

At step 506, the request data passes to Interpreter 130, which uses the query model 1002 to generate multiple interpretations. Each interpretation describes a hypothetical abstract query, reasonably understood (with some likelihood) from the original question text, and (in some embodiments) from additional considerations of context. The request handler 113 can parse the user request/question into discrete terms. The request handler 113 can then search an index ontology for all mentioned terms. In one aspect, the request handler 113 can search server memory 118 and/or external data resources 126 via a knowledge base API. The knowledge base API can be configured to execute the search across the various storage locations and associated protocols and maintain stability in the system 100. The search can result in a fuzzy match for terms; the result of the search can also comprise a list of entity metadata objects. Further, the list of entity metadata objects can be grouped by entity class. The request handler 113 can generate filter criteria based on the grouping hierarchy of the entity class.

In one aspect, the entity class can be organized by a plurality of columns headed by class property key “K”. The data in the columns can be evaluated to determine values based on operations and arguments. The bind function can then define the data structure of a result, such as building abstract predicates from the operations “o” and arguments “v”. The bind function can then bind the abstract predicate to create a filter criterion “F”. For example, the bind function can operate in the following manner: Entity Class “C” is the category of employees. Entity “E” of entity class “C” would be a specific employee, having been configured with a list of mention texts (such as “John Smith”). If the user's input fuzzily matches this mention, then E will be included in the results of Step 506.

Then, the Class C defines a property “K” called “employee_id”. This means that each Entity E (specific employee) can define at least one value for property K (employee_id). For example, Entity E's value for property K can be a pair of values: the operation EQUALS (which can be called “O”); and the arguments of that operation (which can be called “V”). Composing O with V yields and abstract predicate “P”, which can be thought of as a query filter with the left-hand side missing (so the predicate is x=5, which can substitute in a column D for x).

The Request Hander 113 can select “D” from the list of columns known to associate with C through property K. Since K represents employee_id, D can be of any columns containing employee_ids. Once column D has been selected, the Request handler can bind Column D to the predicate to produce our filter criterion “F” (which the Query Factory will be responsible for compiling from an abstract expression into an executable query filter, such as “employee_id=5”).

The Request Handler 113 can predict the entity class E via the interpreter 130. The interpreter can then perform a fuzzy matching rules-based linking within those classes. This approach can vastly reduce the amount of training data necessary. This two-step linking process can allow the models to recognize general patterns of user question structure by treating names/instance IDs as variables in the expression.

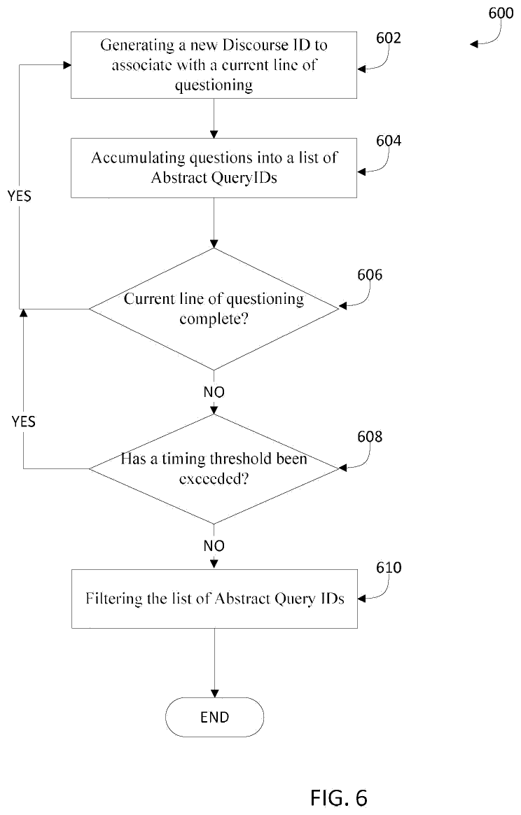

As mentioned earlier, the current disclosure can increase the efficiency of the system by mitigating the cold start problem, which requires multiple search iterations to increase the accuracy of each search and increased storage capacity for each search to execute a query. During a request query, the request handler may search an index ontology for all mentioned terms parsed from the request. The cold start problem can be mitigated by generating a discourse to help train the query model. FIG. 6 depicts a method 600 to establish a discourse (list of pairings) to increase the efficiency and accuracy of a response to a user's question/request. Method 600 can initiate at step 602; the user can generate a new Discourse ID to associate with a current line of questioning. In Step 604, the Interpreter 130 can accumulate the user's requests/questions into a list of Abstract Query IDs and Filtered Query IDs. Each interpretation can be a different understanding of the question, expressed as an abstract query. For example, an Abstract Query ID can comprise the array: 2.1.6.1, 2.3.1.0, 4.2.0, 5.1.0. Further, a filtered Query ID can comprise 2.1.6.1, 2.3.1.0, 4.2.0, 5.1.0: ([column:2, predicates: [date_between (‘2020-01-01’,‘2021-01-01’), date_between (‘2018-01-01’,‘2019-01-01’)], [column: 7, predicates: [equals(‘about.biz.gov’), equals(‘blog.xyz.com’)]]). The abstract query ID and filed query ID can compile into the SQL query for subsequent use.

In Step 606, a user can determine whether the current line of questioning/request is complete. If the user has completed their question session, the YES branch is followed, and a new Discourse ID can be created. Following the NO Branch of Step 606, Method 600 proceeds to Step 608, where a decision is made whether a user makes another request/question within a threshold amount of time, e.g., 5 minutes. If the threshold has been exceeded before the user makes another request, the Method 600, follows the YES Branch, resulting in generating a new Discourse ID. Referring back to Step 608, the NO branch can be followed proceeding to Step 610. In Step 610, these candidate abstract queries can be filtered down to only those queries which execute without throwing an exception. An exception being a result that is unexpected. In a further aspect, Method 600 can include a ranking function that ranks abstract queries relative to the most recent request/response pairings in the current questioning session. Each interpretation can also comprise a likelihood (or more generally, any value) which can be used to rank interpretations as indication of relevance to the user's question.

Referring back to Method 500 in FIG. 5, proceeding to step 508, converted request data exits the interpreter 130 and enters the executor 132. The executor 132 compiles and executes queries against data resources 126. The executor can be loosely coupled to the data resources-instead, imposing an interface upon one or more “execution driver” components, each responsible for low-level implementation of different protocols for different supported data resource types. Step 508 transforms each interpretation into a result.

At step 510, request data exits the executor 132 and enters the formatter 134. Formatter 134 renders results into a human-readable format. In one embodiment, the formatting logic applied to result is configurable by user 14 through the formatter defined on whichever metadata term is associated to the result value. The formatter 134 can implement a value ontology that defines the structure of the queried results. The formatter 134 will transform underlying data values into a different format before delivering answers. The formatter 134 can be configured to determine an output configuration based on the data value. In another aspect, the user or administrator an define the format. In an alternative embodiment, the formatter can recursively implement another formatter configuration. For example, when the formatter 134 receives a database value it also receives a Column ID reference. This reference is then used to lookup the column's associated formatter configuration.

At step 512, the request handler 113 returns results to the user question 15. In one embodiment, the response is limited to the most likely answer (the answer originating from the most likely interpretation.). In one embodiment, the response includes the “top N” most likely answers (where N may be a user-defined query parameter). In general, embodiments of request handler 113 can implement the response as a single answer or as multiple answers, optionally filtered by properties of those answers (including the likelihood of the interpretation which defined the answer).

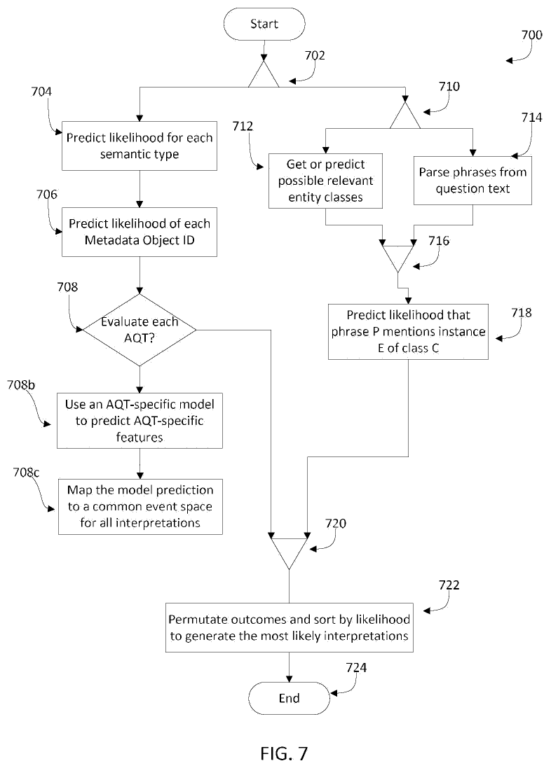

As discussed earlier in step 506, the interpreter 130 can generate a set of interpretations from the question received in step 504 and provide the input for step 508. In one aspect, the set of interpretations is a mapping that can comprise a network of layered classifiers (trained over example questions) to predict the likelihood of each interpretation (outcome in interpretation space) given the observed request. Method 700, as depicted in FIG. 7 can provide additional detail regarding the data flow of the request through a query model.

At step 702, the data flow can be forked into two parallel flows. These parallel data flows can ultimately join again at step 720. The fork symbol in steps 702 and 710 are meant to indicate the non-blocking (parallelizable) nature of the two outgoing flows. In one embodiment, these parallel flows can be executed in parallel. In another embodiment, the two flows can be executed sequentially. At step 704, a classifier predicts the semantic type of the request (predicting the answer's ontological class e.g., “person,” “place,” and/or “time” by inference of understood terms in the input e.g., “quien”, “ou” or “when” as determined by their significance within a corpus of training examples). Semantic types can include the type of data and format of the data, as shown in Table 1.

TABLE 1
Semantic Types for Data

| [symbol] Value | Description | Example |
|---|---|---|
| YEAR | [symbol] | ″2017″ |
| YEAR_MONTH_DAY_HOUR | [symbol] | ″ [symbol] ″ |
| YEAR_MONTH_DAY_SECOND | [symbol] | ″ [symbol] ″ |
| COUNTRY | Country | ″United States″ |
| COUNTRY_CODE | Country Code | ″ [symbol] ″ |
| CONTINENT | Continent | ″Americas″ |
| CONTINENT_CODE | Continent Code | ″019″ |
| CITY | City | ″ [symbol] View″ |
| CITY_CODE | City Code | ″1014044″ |
| METRO_CODE | Metro Code | ″200807″ |
| LATITUDE_LONGITUDE | Latirude and Longitude | ″ [symbol] ″ |
| NUMBER | Decimal Number | 14 |
| PERCENT | Decimal percentage | ″ [symbol] ″ |
| | (can be over 1.0) | |
| TEXT | Free form text | ″Here is some text″ |
| [symbol] | true or false | TRUE |
| URL | A URL as text | ″https://www.google.com″ |
| [symbol] | a link with a text label | ″ [symbol] ″ |
| IMAGE | A URL of an image | ″ [symbol] ″ |
| IMAGELINK | A link with an image | ″ [symbol] ″ |

[symbol]

indicates data missing or illegible when filed

The corpus can be maintained through configuration API 120, creating a feedback mechanism which allows the system to properly discriminate slowly changing intended concepts in the face of faster paced changes in user vocabulary. The Interpreter 130 can also evaluate the probability that an abstract query is valid. The probability evaluation vastly increases performance since a majority of classifier output permutations will not represent valid abstract queries. This query model quickly aggregates the likelihood of any outcomes map onto the same abstract query.

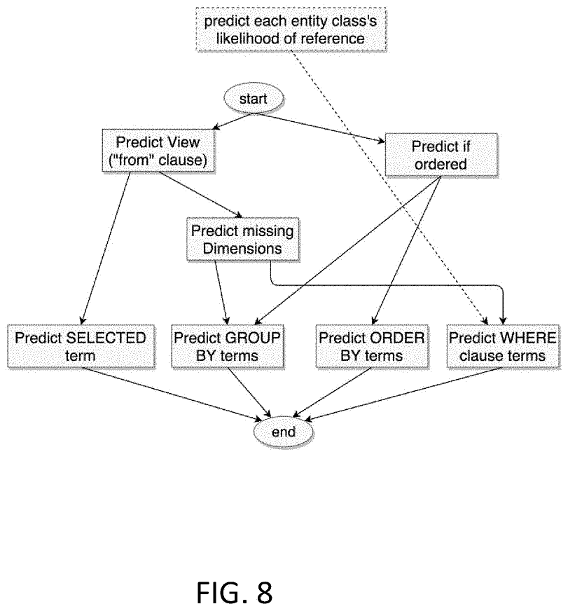

In one aspect, the classifier model implements a deep neural network for both training the query model and predictions of abstract query types, AQTs. In a further aspect, the classifier is a multi-task classifier, wherein a combination of several classification tasks all working together. Each classifier can encode as input the question text as a document vector. As shown in FIG. 8, the neural network can have multiple layers to define and predict Abstract Query Types (AQT) based on a user defined set of grammar.

In an alternate embodiment, an abstract query type can be derived by a token-based bag of words approach. Under the bag-of words process, a user's question/request can be vectorized wherein each word in the question is converted to a number. Each number can be classified as a token. The list of tokens can be converted into an array of word vectors. The tokens can also be converted into token IDs, which can represent to bag of words. The entirety of the list can be converted into a document vector. These document vectors can be input into a column model. The column model can predict how the model participates in a given question. The column model can use stacked self-attention layers to generate a context vector. This context vector can then pass to three output tasks: role, function, and sort. The role output task determines “is this column a group, a measure, or neither (in this question). The function output task determines “if this column is a measure, what is the aggregation function ID to apply (count/sum/average/etc.). The sort determines “if this column is a measure, what is the sort of direction to apply”. The column model can be embedded inside the Query model to concatenate the outputs of the Column models and treat that as the input to the Query model's output tasks. Next, the Query model's output tasks can be fed forward in a hierarchical fashion similar to the neural network in FIG. 8.

At step 706, another classifier predicts the intended metadata object ID. The prediction of the metadata object ID can be determined by implementing a data abstraction layer (metadata model). The metadata model can comprise a plurality of metadata objects. Each of the metadata objects and comprise references to user-defined data resource configurations. The data resource configurations can comprise mappings to external data resources 126 as well a credential and security data. The metadata model can generate term configurations. The term configurations can be protocols that define how a query factor (grammar) can define query expressions based on a run-time interpretation of the user's question. In a further aspect, the model can comprise reference to zero or one user-defined formatter types, comprising a reusable configuration how to format values before returning them to the user. The metadata model can also comprise view configurations that abstractly describe a logical view of data available.

An example implementation of the metadata model can comprise responding to the question “how much do people make in California?” which is conceivably answerable from multiple sources (e.g., from object #1 describing a table of filed tax returns at a household level or from object #2 describing the paystubs of individual employees). In one embodiment, this classifier takes a non-informative prior. In one embodiment, this classifier takes an informative prior (generally taken from the outcome of another classifier or as part of a belief network). At step 708a, the control flow enters a loop which iterates over each abstract query type, designated AQT. Abstract query types are a concept necessarily arising in embodiments that implement step 508 differently depending on the data resource type (as described earlier with reference to the concept of “drivers”). In one embodiment, there can be one abstract query type (e.g., ANSI-SQL) that is determined from a degenerate case of looping. In step 708b, a model “M” (whose event space is defined by the features of the current AQT) predicts the likelihood of outcomes in the AQT's feature space. This prediction generally involves one or more classifiers. In step 708c, the likelihoods predicted in the AQT event space are mapped into the event space shared by all interpretations. This event space is defined by the features common to all interpretations (abstract queries) and allows for abstract processing (including the ability to rank interpretations by likelihood). At the end of loop in decision block of step 708a, control merges into join step 720.

In one embodiment, the requesting user 14 can provide filters in their request to “short-circuit” the outcomes of the above-mentioned models. For example, the user may select a filter option “include places only” in the user interface 112, and this may cause the Interpreter 130 to “short-circuit” the prediction in step 704 to only the requested outcome. In one embodiment, different features are predicted by classifiers on different layers and the account of likelihood between layers propagates the “short-circuit” to deeper layers.

In step 710, control forks into two non-blocking tasks and these flows merge again in join step 716. The steps between 710 and 716 implement the task of Named Entity Linking, which can be summarized as the problem of identifying an “instance” E (often represented by a knowledge base ID e.g., “state 36”) by finding mentions (e.g., naming expressions like “New York”) usually extracted by parsing phrases in a longer expression (e.g., “where should I live in New York?”).

In step 714, the user's question can be broken into phrases. In one embodiment, the phrase parsing can be implemented by a phrase-chunking grammar which extracts fully projected determiner phrases and noun phrases. In such an embodiment, the example question “where should I live in New York?” yields the phrases “I” and “New York”. In step 712, likelihoods are assigned to various entity classes. In one embodiment, the configuration API 120 is used to configure the available entity classes. Entity classes are defined with a name (e.g., “states”) and a linking strategy.

In step 718, each entity class can be checked against each phrase and the instances within the class are scored against the phrase text. In one embodiment, each phrase can match either zero or one class, with phrases matching the class having the highest scoring instance match. In the phrase “where should I live in New York” the phrase “New York” would perfectly match the associated State instance, while Idaho (abbreviated ID) would only partially match the phrase “I”, linking the class to “New York”.

When allowing users 14 to define an Entity Class, embodiments of the present invention may support one or more linking strategies, including: keyword based strategies (e.g., link fuzzy matches for “this year” or “2018” to the ID value “20180101”); user-based strategies (e.g., link “I” or “my” a special value whose evaluation is a function of the current user's credentials); external knowledge base strategies (e.g., link fuzzy matches on column “name” or “abbreviation” to the matching value in the “ID” column of a certain table).

In one embodiment, each entity class is predicted as an independent binary event. In one embodiment, the a priori chances for each entity class are conditioned by the a posteriori distribution over metadata object IDs In one aspect, the entity classes can be defined by an entity ontology. The entity ontology can be a relationship structure implemented by the processor. In a further aspect, the processor can comprise a processor module that identifies individual entities-based user provided phrases. The user provided phrases can be extracted from the user's initial request. The processor module via the entity ontology can define a plurality of user-defined entity classes. These user-defined classes can also include certain properties, including: abstractly representing a conceptual group of individuals; a reference to a known entity linking strategy; a configuration for the know entity linking strategy; and associating the configuration with the strategy through the processor module which determines individual instance within the entity class based on the phrases extracted from user input. In a further aspect, the processor or processor module can define a plurality of user defined entity contexts. The user defined entity contexts can define properties including: abstractly representing a domain of related conceptual groups and a collection of references to one or more suitable entity classes.

In one aspect, predicting recommended queries can comprise synchronous recommendations. The synchronous recommendation can be used when recommendations must be calculated in the context of a current user interaction. For example, consider the Search Flow interaction on the frontend. In the context of the Question/Answer API, there is a step wherein the abstract queries can be by their likelihoods under the model. This sorting process can be modified to rank queries by the weighted geometric mean of their likelihood and predicted rating, producing a sort of function which considers not only the query's relevance to the question itself but also the query's relevance to the given user (or group of users.) The weighting of the prediction step would scale between 0 and 1 as a function of how much support the recommendation engine models have for the given user (or group of users). In another aspect, an asynchronous recommendation can be used when recommendations should be calculated outside the context of any user interaction. For example, consider the discovery flow interactions on the frontend. These interactions are triggered by system events external to user interaction. One component of the discovery flow is a “did you know” section, which is populated with items that the models predict as relevant to the user or their current session. The converted dataflows from steps 708 and 718 can be provided to join step 720. From step 720, the data can proceed to step 722 wherein Method 700 can end at step 724.

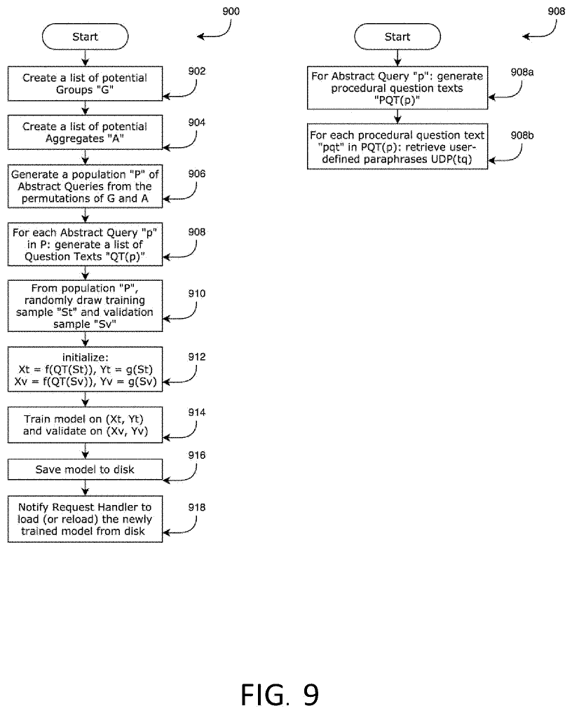

FIG. 9 is a flow chart diagram illustrating an example semi-supervised training method 900. Steps 902, 904 and 906 generate a population of viable intents. Each intent may be an Abstract Query ID or a Filtered Query ID. Step 908a creates a list of machine-generated question texts for each given intent. Step 908b extends list 908a with optional user-generated paraphrase texts for each machine-generated question text from 908a. Step 910 pairs the questions from 908 with the intents from 906, producing the superset of possible training data. Step 910 may further randomly sample the superset of examples to create separate example subsets. Step 912 initializes the input X and output Y of query model 1002. Step 912 may divide X and Y into training and validation sets as determined by random sampling step 910. Step 914 then trains the query model 1002 on the training dataset from step 912. Step 914 may use the validation dataset to measure the query model 1002's ability to generalize beyond the observed training dataset. Step 916 saves the query model 1002 to disk. Step 918 triggers request handler 113 to reload its instance of query model 1002.

In relation to FIG. 1, training method 900 can be executed by the processor of training module 164. The training module 164 may be a pool of one or more processes running on the backend computer 110. Method 900 can start when the training module 164 receives training job 166. Each of the one or more process can be a training job 166. Further, a particular training job 166 can be scheduled into the training module 164 when the training management API 168 receives a training request 170. A training request 170 may be initiated from frontend computer 106 whenever administrator 16 uses configuration application 114 to make any change to configuration API 120.

Alternatively, training request 170 may be deferred until some explicit secondary event. For example, administrators 16 may send several requests to the configuration API 120 in a row. These changes would not take immediate effect, instead being accumulated into a batch of pending changes. This batch would accumulate by the processor of configuration API 120 and stored in a storage memory 118 (such as an application database, file, message queue) associated with configuration API 120. Once administrators 16 are satisfied with their changes, the administrator may confirm changes in the configuration application 114 via the user interface.

Method 900 initiates inside the processor of training module 164. The steps of method 900 can provide a solution to the cold start problem at a time of training the query model 1002 to predict Abstract Query IDs from natural language questions. In turn, method 700 constitutes the solution for taking the probabilities of ambiguous interpretations and executing the most likely intents as executable database queries. Together, these methods allow the query model to answer a user's questions without requiring any manually defined examples. Optionally, method 900 allows for step 908b as a way for users to teach the system new structures of question, by adding user-defined paraphrases through the configuration API 120.

When method 900 is initiated, at step 901a, training module 164 first retrieves a copy of the current configuration by sending a request to the configuration API 120. The training module 164 loops over all datasets in the current configuration. Here, a “dataset” may refer to a named table (when querying RDBMS), a named collection (when querying a Document Store), a request URI (when querying an API), and so on. In step 901b, for each dataset “d” in the current configuration, training module 164 then loops over each data element “c” of dataset d. Here, a “data element” may refer to a column (of a table, when querying a RDBMS), a property (of a collection, when querying a Document Store), a parameter (of a request, when querying an API), and so on.

Proceeding to step 901c, for each data element “c”, the training module 164 then looks up the semantic type of “c” from the properties of “c” defined using the configuration API 120. The semantic type of “c” may be a value taken from a system-defined enumeration. The purpose of the semantic type is to allow users to restrict a column from performing certain operations, even if c's data type allows those operations. (Example: columns “employee_id” and “hours worked” may both be integers in a database. It is always possible to take the average of an integer. However, “average (hours worked)” is a meaningful number whereas average(employee_id) is generally meaningless. This difference in expected behavior demonstrates a difference in semantic types between the two columns.)

One semantic type may be “measure.” For example, an administrator may mark a data element “hours worked” as a measure to indicate that it can be used in aggregation (“SELECT average(hours_worked)”) not never as a group (“GROUP BY hours_worked”). A semantic type of “measure” may be further divided based on differences in how to generate question text during step 908. If c is a measure, then it has some natural unit (count of people, length of time.) The enumeration of semantic types may include subtypes of measure, representing “discrete measure” (a count of people) as opposed to a “continuous measure” (a length of time.) The difference in unit of measure could then be used by step 908 to select a different template for question text, depending on the different linguistic behaviors between count nouns (discrete) vs mass nouns (continuous.)

Another semantic type of “dimension” may be used to mark a data element (such as “employee_id”) as a value which cannot be meaningfully aggregated, save for taking a distinct counting. The “dimension” type may be further divided into subtypes, each representing differences in behavior between underlying data types (time, text, boolean, integer id.)

Proceeding to step 901d, the training module 164 can then take the semantic type of each data element “c” and determines the possible query roles by which c might participate in a query. For example, in a SQL query there may be three roles by which a column “c” might be selected: namely, by aggregation, or as a group, or as neither. Consider a primary key column “employee_id”. This column might participate as a group in one query (“SELECT employee_id, sum(hours_worked) FROM hr.timesheets GROUP BY employee_id”) while participating as an aggregation in another query (“SELECT count(employee_id), department FROM hr.org_chart GROUP BY department”) while participating as neither in yet another query (“SELECT employee_id, date, hours_worked FROM table.”) The list of available query roles for “employee_id” is a function of its semantic type. The available possibilities are known at the time the query model 1002 is initialized.

In Step 902, the training module 164 can then use the output of steps 901a-d to collect a list of data elements “G” which are available to act in the role of group. In Step 904, the training module 164 can then use the output of steps 901a-d to collect a list of all data elements “A” which are available to act in the role of aggregate.

In Step 906, the training module 164 can then generate the full population “P” of potential training queries “p” (that is, Abstract Query IDs.) It does this by iterating combinations of data elements “c” related by data source “d”. A maximum number of columns to consider per example may be defined, such as 3. A maximum number of groups per example may be defined, such as 1. A maximum number of aggregates per example may be defined, such as 2.

In Step 908, the training module 164 can then create a list of semi-supervised question text examples for each query “p” of the population “P” created by the training module 164 in step 906. In a further aspect, step 908 can comprise multiple steps. In Step 908a, the training module 164 can then create a list of machine-generated question texts based on the Abstract Query ID “p” which is taken as a command which specifies which columns act in which query role. The command may be executed by an NLG module which defines production grammars (e.g., templates, EBNF formulas) for producing question texts that take into account the roles and semantic types of each column in Abstract Query ID “p”. The NLG module can be a custom implementation written in python.

In Step 908a, the training module 164 can consider uses of the 1^{st} element of the Abstract Query ID to determine the intended answer as either tabular or scalar. For example, an Abstract Query ID having form 2.x.x.x.x is a tabular query as opposed to a scalar query 1.x.x.x.x. These queries would have different results. A scalar query returns a single row, whereas a tabular question can return multiple rows. This difference can be enough to change the phrasing of a question, even if the columns are kept the same. For example, if our columns are “purchase price” and “sale date” then the question “Which month had the highest total sales?” will give a scalar answer, while “What are our total sales by month?” will give a tabular answer. In Step 908a, the training module 164 may disregard the 2^{nd} and 3^{rd} elements of the Abstract Query ID, which represent the dataset “d” (table, view, collection, URI.)

In Step 908a, the training module 164 can take the groups (4^{th} element) and aggregates (5^{th} element) of the Abstract Query ID to determine vocabulary terms to substitute into the available templates based on the answer type (tabular or scalar.) For example, the columns “sale price” and “product category” might be configured with synonyms through configuration API 120. Thus, allowing the training module 164 to use a single template to generate equivalent question texts (“What's the average sale price by product category” as well as “What's the average sales per product type.”)

In Step 908b, the training module 164 can then evaluate each machine-generated question text from the output in step 908a. For each machine-generated question text “pqt” determined in step 908b, the training module 164 can then find any user-defined paraphrases of pqt. Paraphrases may be configured as a resource in the configuration API 120.

Further, in step 908, the training module 164 can then combine the machine-generated example questions output from 908a with the user-defined example paraphrases output from 908b, and groups all these questions as equivalent training examples of the current Abstract Query ID “p”.

In Step 910, the training module 164 can pair the questions from output from step 908 with the intents output from step 906, producing a semi-supervised population of training examples. Optionally, in step 910, the training module 164 may (aggressively) sample the full population down to a fraction of the full training data. For example, in step 910, the training module 164 may divide the full population into a 10%-10% train-test split.

Any train-test split by the training module 164 in step 910 can ensure that the resulting training/validation sets preserve the original distribution of token cooccurrences in the full population of question texts. This may be done by transforming the population of examples and then dividing it with an iterative multi-label stratified train-test split. For example, in step 910, the training module 164 can transform the population of examples by: taking each example question, using a tokenizer to split each question into a sequence of token IDs, and using a multi-label binarizer convert these token IDs into a fixed-size token indicator array. This gives each index in the population a set of stratification labels, which can then be passed to an off-the-shelf method for performing an iterative multi-label stratified train-test split (as from a library, such as scikit-multilearn or iterative-stratification in python.) The multi-label binarizer can also be off-the-shelf (as from a library, such as sklearn in python.) The tokenizer can also be off-the-shelf (as from a library, such as sklearn or keras in python.) Steps 902 through 910 together constitute the creation of our semi-supervised training data.

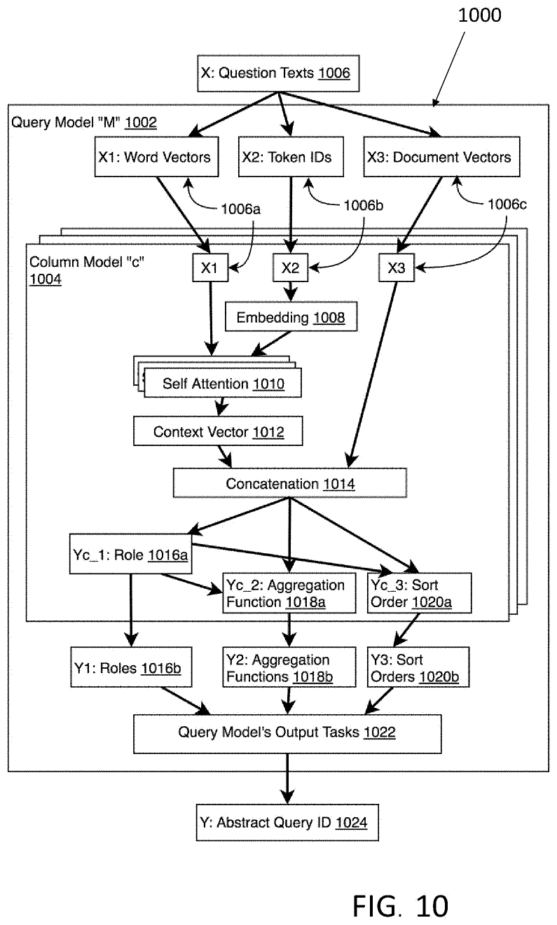

In Step 912, the training module 164 can then initialize the query model 1002. Turning to FIG. 10, a new event 1000 can include one instance per data element “c” of column model 1004. The outputs of column model 1004 can be initialized per the acceptable roles/aggregation functions/sort directions expected from the semantic type of “c”. including copies of the column model 1004 each responsible for learning about a different data element “c” in the configuration of method 900. In Training step 912, the training module 164 can assign the sampled question texts to query model input “X” 1006. During the training step 912, the training module 164 also assigns the associated sampled Abstract Query IDs to the query model 1002's output “Y” 1024.

During training step 914, each column model 1004 will learn to attend to the presence or absence of its assigned data element “c”. And the query model 1002 will learn to relate the outputs of all column models 1004 in terms of these restricted training questions. Later, when a user asks a question through method 500, the query model 1002 is then able to generalize to accurately predict larger combinations of columns than it was trained on during step 914.

In Step 914, the training module 164 can train the query model 1002 on the Xt/Yt training dataset from step 912. In Step 914, the training module 164 may use the validation subset Xv/Yv from 910 to ensure the query model does not overfit, by measuring the query model 1002's performance against the validation dataset. If the query model 1002 fails to converge (as indicated by the validation performance) then method 900 can repeats from step 910, taking a new random sample. This continues until convergence, or until a maximum number of retries (for example 3) is reached.

If the query model 1002 fails to converge after step 914, method 900 ends without continuing to step 916. In this case, training module 164 may send a request to the training management API 168 marking the current training job 166 as a failure.

If the query model 1002 successfully converges after step 914, method 900 proceeds to step 916. In step 916, the successfully trained query model 1002 is saved to disk. Step 916 proceeds to step 918. In step 918, the training module 164 sends a request to training management API 168 marking the current training job 166 as a success. In this case, the training management API 168 triggers request handler 113 to reload the newly trained version of query model 1002. This new revision of the query model 1002 is then used by methods 500 and 700 to handle future requested questions.

FIG. 10 is a block diagram of an example query model 1002 including example column model 1004. The example query model 1002 has one column model 1004 per data element “c” that exists in the configuration related by method 900. These models 1002/1004 are only examples for the SQL abstract query type and are not intended to suggest any limitation as to the scope of use or functionality of model architectures 1002/1004. Neither should the models 1002/1004 be interpreted as having any dependency or requirement relating to any one or combination of components illustrated in the exemplary models 1002/1004.

The query model 1002 can compromise an input X 1006 and output Y 1024. In step 914, the training module 164 uses a neural network training function (such as Keras's model. train) to pass semi-supervised training and validation examples from step 914 into input X 1006 and output Y 1024.

In the example input X 1006, the training module 164, in step 914, further processes the question texts as input X 1006 into three additional example components: array X1 1006a, array X2 1008b, and array X3 1008c. Array X1 1006a is a 3D tensor of word vectors. Array X1 1006a is calculated by passing question texts at input X 1006 to a word embedding model. This word embedding model may be pre-trained. The calculation of X1 1006a may occur in the same processor as executes method 900. Alternatively, the calculation may occur in the processor of a vectorization API 172 running on backend computer 110.

Array X2 1006b can a 3D tensor of token IDs. Array X2 1006b may be calculated by passing the question texts at input X 1006 into a tokenization utility provided by a neural network framework that may be used to implement models 1002/1004. Array X3 1006c is calculated by passing question texts at input X 1006 to a document embedding model. In one aspect, the document embedding model may be pre-trained. The calculation of X3 1006c may occur in the same processor as executes method 900. Alternatively, the calculation may occur in the processor of a vectorization API 172 running on backend computer 110. Each example column model 1004 can receive the same set of arrays 1006a/1006b/1006c. Only one copy of each array needs to be held in memory by the processor of training module 164.

Each example column model 1004 contained by query model 1002 includes its own embedding layer 1008 which takes array X2 1006b as input. The embedding layer 1008 may be implemented using out-of-the-box methods (from a library such as Keras) or by a extending a custom layer by extending such a library. The embedding layer may be configured with a small, fixed number of embedding dimensions (such as 10) sufficient to capture the variety of unique keywords that might activate the data element “c” which defines a given column model 1004.

Each example column model 1004 “c” concatenates its instance of embedding layer 1008 with the word vector array X1. This concatenation becomes the input to c's instance stack of one-or-more self-attention layers 1010. Each self-attention layer in the stack 1010 may be implemented using out-of-the-box methods (from a library such as Keras) or by a extending a custom layer by extending such a library. The final self-attention layer in the example stack 1010 can becomes the example context vector 1012.

Each example column model 1004 “c” can concatenate its instance of context vector 1012 with the document vector input X3. This concatenation 1014 becomes an input to Model c's 1004 output: role output 1016a, aggregation function output 1018a, and sort order output 1020a.

Example outputs 1016a/1018a/1020a may be implemented as a single-layer classifier, for example a dense layer using the softmax activation function and with a number of units equal to the number of classes for the given output task. The number of classes is a pure function of the semantic type for whatever data element “c” defines a given instance of column model 1004. The example 1016a has between 1 and 3 role classes, representing: group, aggregate or neither. The example 1018a has between 1 and 5 aggregation function classes, representing: none, count, sum, average, median. The example 1020a has either 1 or 3 sort order classes: none, ascending, descending.

The example output 1016a is further concatenated to the previous concatenation 1014. This concatenation acts as the input to example outputs 1018a/1020a. Feeding outputs as inputs to other outputs in this manner allows the column model architecture forces backpropagation to obey any statistical dependency relationships which may be required between the output variables 1016a/1018a/1020a.

Query model 1002 then concatenates every example c's instance of output 1016a/1018a/1020a to create an example input layer 1016b/1018b/1020b. These examples input layers 1016b/1018b/1020b can then become the input to the query model outputs tasks 1022. An example architecture of query model output tasks 1022 is given in FIG. 8.

During training step 914, the query model output tasks 1012 are connected to the training example Abstract Query IDs 1024 taken from step 912. In context of interpretation step 504, during disambiguation steps 702-708, the interpreter 130 passes the user-provided question text to the query model 1002 which returns a list of predicted marginal class probabilities for each of the query model output tasks 1022. These marginal class probabilities are then mapped into a joint event space by the interpreter 130 in step 708c, which gives a list of Abstract Query IDs each ranked by their joint probability under the query model 1002.

In this way, method 700 can account for the ambiguity in a user's question using one or more query models 1002 “M” as selected by interpreter 130 from the available abstract query types (such as SQL, Document Store, REST API.) Further, the joint probabilities at step 708c can be adjusted by the immediate history of previous probabilities from the users' discourse, allowing the interpreter 130 to increase the probability of data elements which have been frequently requested by a given user in the short-term.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

While the disclosure has been described in connection with what is presently considered to be the most practical and various embodiments, it is to be understood that the disclosure is not to be limited to the disclosed embodiments, but on the contrary, is intended to cover various modifications and equivalent arrangements comprised within the spirit and scope of the appended claims.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for generating a natural language response to a query, the method comprising:
receiving request data to a processor,
identifying, by the processor, a query model;
generating, by the processor, a plurality of abstract queries, wherein each abstract query is an interpretation the request data, and wherein generating the plurality of abstract queries comprises:
parsing the request data into a plurality of terms, and
identifying at least one classifier for each term of the plurality of terms;
implementing, by the processor, the query model comprising:
identifying a protocol language associated with at least one external data resource,
transmitting the plurality of abstract queries to the at least one external data resource,
determining a match for each term from the plurality terms of the request data to a resource term stored at a data resource,
in response to determining the match for each term from the plurality of terms, generating at least one query result with a bind function, wherein the bind function defines a data structure of the at least one query result,
ranking the at least one query result based on the at least one classifier, and
identifying a template for providing the at least one query result in the natural language response; and
converting the at least one query result into a natural language response.

2. The method of claim 1, wherein the bind function is configured to filter the at least one query result based on the at least one classifier.

3. The method of claim 1, further comprising:
identifying, by the processor, training data stored in a memory device in communication with the processor;
generating, by the processor, at least one of: a plurality of training abstract queries or a plurality of training filtered queries based on the training data;
generating, by the processor, a plurality of training question texts based on the at least one of: the plurality of training abstract queries or the plurality of training filtered queries;
generating, by the processor, a plurality of training paraphrase texts based on the plurality of training question texts;
generating, by the processor, a training data superset by pairing the plurality of training paraphrase texts and the training data;
implementing, by the processor, the query model based on the training data superset; and
storing the query model at the memory device in communication with the processor.

4. The method of claim 3 further comprising:
separating the train data superset by random sampling into a training sample set and a validation sample set;
implementing the query model based on the training sample set;
implementing the query model based on the validation sample set; and
determining a convergence between a first result associated with the query model based on the training sample set and a second result associated with the query model based on the validation sample set.

5. The method of claim 1, further comprising generating a discourse, wherein the discourse comprises a plurality of question pairings, each question pairing comprising previous request data and a result associated with the previous request data.

6. The method of claim 5, wherein the discourse is stored on an internal data resource associated with the processor or an external data resource, and wherein the discourse is associated with a discourse identification.

7. The method of claim 1, wherein receiving the request data comprises:
authorizing the query for a response to the request data, and
generating an event log for the query.

8. The method of claim 1 further comprising:
generating at least one execution driver by the processor,
matching the at least one execution driver to an abstract query based a protocol associated with the least one data resource.

9. The method of claim 1 wherein a classifier comprises at least one of: entity class, semantic type, property, metadata object or value.

10. A system for generating a natural language response to a query comprising:
a non-transitory computer readable memory, configured for storing data; and
a processor, coupled to the non-transitory computer readable memory, configured to:
receive request data to a processor,
identify a query model stored on the non-transitory computer readable memory;
generate, a plurality of abstract queries, wherein each abstract query is an interpretation the request data, and wherein generating the plurality of abstract queries comprises:
parsing the request data into a plurality of terms, and
identifying at least one classifier for each term of the plurality of terms;
implement the query model by:
identifying a protocol language associated with at least one external data resource,
transmitting the plurality of abstract queries to the at least one external data resource,
determining a match for each term from the plurality terms of the request data to a resource term stored at a data resource,
in response to the match for each term from the plurality of terms, generate at least one query result with a bind function, wherein the bind function defines a data structure of the at least one query result, and
rank the at least one query result based on the at least one classifier,
identify a template for providing the at least one query result in the natural language response; and
convert the at least one query result into a natural language response.

11. The system of claim 10, wherein the bind function is configured to filter the at least one query result based on the at least one classifier.

12. The system of claim 10, wherein the processor is further configured to:
Identify training data stored in a memory device in communication with the processor,
generate at least one of: a plurality of training abstract queries or a plurality of training filtered queries based on the training data;
generate a plurality of training question texts based on the at least one of: the plurality of training abstract queries or the plurality of training filtered queries;
generate a plurality of training paraphrase texts based on the plurality of training question texts;
generate a training data superset by pairing the plurality of training paraphrase texts and the training data;
implement the query model based on the training data superset; and
store the query model at the memory device in communication with the processor.

13. The system of claim 12 wherein the processor is further configured to:
separate the train data superset by random sampling into a training sample set and a validation sample set; and
implement the query model based on the training sample set;
implement the query model based on the validation sample set; and
determine a convergence between a first result associated with the query model based on the training sample set and a second result associated with the query model based on the validation sample set.

14. The system of claim 10, wherein the processor is further configured to generate a discourse, wherein the discourse comprises a plurality of question pairings, each question pairing comprising previous request data and a result associated with the previous request data.

15. The system of claim 14, wherein the discourse is stored on an internal data resource associated with the processor or an external data resource, and wherein the discourse is associated with a discourse identification.

16. The system of claim 10, wherein the processor being configured to receive the request data comprises is further configured to:
authorize the query for a response to the request data, and
generate an event log for the query.

17. The system of claim 10 wherein the processor being further configured to:
generate at least one execution driver by the processor;
match the at least one execution driver to an abstract query based a protocol associated with the least one data resource.

18. The system of claim 10 wherein a classifier comprises at least one of: entity class, semantic type, property, metadata object or value.

19. One or more computer-readable media storing computer-executable instructions that, when executed by at least one processor, configure at least one processor to perform operations comprising:
receiving request data to a processor,
identifying, by the processor, a query model;
generating, by the processor, a plurality of abstract queries, wherein each abstract query is an interpretation the request data, and wherein generating the plurality of abstract queries comprises:
parsing the request data into a plurality of terms, and
identifying at least one classifier for each term of the plurality of terms;
implementing, by the processor, a query model by:
identifying a protocol language associated with at least one external data resource,
transmitting the plurality of abstract queries to the at least one external data resource,
determining a match for each term from the plurality terms of the request data to a resource term stored at a data resource,
in response to determining the match for each term from the plurality of terms, generating at least one query result with a bind function, wherein the bind function defines a data structure of the at least one query result, and
ranking the at least one query result based on the at least one classifier,
identifying a template for providing the at least one query result in the natural language response; and
converting the at least one query result into a natural language response.

20. The one or more computer-readable media of claim 19, wherein the processor is further operable to perform operations comprising:
identifying, by the processor, training data stored in a memory device in communication with the processor;
generating, by the processor, at least one of: a plurality of training abstract queries or a plurality of training filtered queries based on the training data;
generating, by the processor, a plurality of training question texts based on the at least one of: the plurality of training abstract queries or the plurality of training filtered queries;
generating, by the processor, a plurality of training paraphrase texts based on the plurality of training question texts;
generating, by the processor, a training data superset by pairing the plurality of training paraphrase texts and the training data;
implementing, by the processor, the query model based on the training data superset; and
storing the query model at the memory device in communication with the processor.
